(19) United States
(12) Patent Application Publication
(10) Pub. No.: US 2002/0099872 A1
(43) Pub. Date: Jul. 25, 2002

(54) Allocating registers for use in programming code modification

(76) Inventors: Vinodha Ramasamy, Campbell, CA (US); Jenn-Yuan Tsai, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/765,931

(22) Filed: Jan. 19, 2001

(51) Int. Cl. G06F 3/00

(52) U.S. Cl. 710/1

(57) ABSTRACT

Techniques are disclosed for allocating an N number of registers for use in conjunction with programming code modification, which is usually implemented in code instrumentation. During code instrumentation, new code or “probe” code is added to the block, and, consequently, the original code is changed and/or relocated, resulting in a modified block. In one embodiment, a block of code is associated with an “alloc” statement that uses parameters based on which the programming system allocates the stacked registers for use in that block. Further, the parameters of an alloc statement include an input parameter identifying a number I of input registers, a local parameter identifying a number L of local registers, and an output parameter identifying a number O of output registers. Consequently, the I number of input registers, the L number of local registers, and the O number of output registers are to be allocated. In these conditions, the number N is added to the number O so that additional number N of registers is to be allocated for use in the modified block.

### FIELD OF THE INVENTION

The present invention relates generally to programming code modification and, more specifically, to allocating registers for use in such modification.

### BACKGROUND OF THE INVENTION

Program code analysis tools based on code instrumentation may require that additional (or probe) code be inserted into the original code of a program and/or that the original code be modified. Some examples of probe code include adding values to a register, moving the content of one register to another register, moving the address of some data to some registers, etc. As a result, code instrumentation may cause changes in the content values of registers. Code instrumentation may be done both statically and dynamically (i.e., while the program is running).

Registers refer to special, high-speed areas storing data to be processed by the program code. For the instrumented code to maintain the same programming behavior as the original code, code instrumentation requires that the content of registers as seen by the original code remains unchanged. In one approach, the content values of registers in the original code are saved so that these values may be restored after the registers are used in code instrumentation. However, save and restore operations are expensive and increase memory traffic.

A free register is a register that can be used in code instrumentation without violating program correctness. Compiler annotations and data flow analysis may provide information to identify free registers. Unfortunately, compiler annotations require specific support from the compiler while data flow analysis is expensive.

Based on the foregoing, it is clearly desirable that mechanisms be provided to solve the above deficiencies and related problems.

### SUMMARY OF THE INVENTION

The invention, in various embodiments, provides techniques for allocating an N number of registers for use in conjunction with programming code modification or code instrumentation. In one embodiment, a block of code is associated with an “alloc” statement that uses parameters to determine the size of a stack frame corresponding to the number of registers used in the block of code. The parameters of an alloc statement include an input parameter identifying a number I of input registers, a local parameter identifying a number L of local registers, and an output parameter identifying a number O of output registers. In one embodiment, the number N is added to the number O so that the additional number N of stacked registers are available for use in the modified/instrumented block of code.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows examples of how registers are allocated by alloc statements in accordance with one embodiment;

FIG. 2 shows an example of the correspondence between the alloc statements, the stack frames, the stacked registers, and the physical mapped registers;

FIG. 3 is a flowchart illustrating the method steps in accordance with one embodiment;

FIG. 4 shows an example of how four registers are allocated for use in code instrumentation, in accordance with one embodiment; and

FIG. 5 shows an exemplary computer upon which embodiments of the invention may be implemented.

### DETAILED DESCRIPTION OF VARIOUS EMBODIMENTS

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

The invention, in various embodiments, provides techniques for allocating a number N of registers for use in conjunction with modifying a block of programming code, which is a sequence of instructions in which an execution transfer into the block operates only through the first instruction in the sequence. A function in the C or C++ language, a procedure in the Pascal language, or a subroutine in the FORTRAN language may itself be a block, but typically comprises multiple blocks. For illustration purposes, the term procedure used in this document is interchangeable with a block of programming code, and a procedure calling another procedure is referred to as a caller while the procedure being called is referred to as a callee.

Further, the techniques disclosed herein may be used and thus explained in the context of code instrumentation. However, these techniques are not limited to code instrumentation, but are applicable to situations in which allocating registers for various uses is desirable.

### The Stacked Registers

Typically, registers refer to special, high-speed areas storing data to be processed by the program code. In one embodiment, in the context of the IA-64 Architecture of Hewlett-Packard Company of Palo Alto, Calif., a general register file is divided into a subset of static registers and various subsets of stacked registers. The static subset, consisting of 32 registers from GR0 to GR31, is visible to all procedures of a program. The stacked subsets may be used by different procedures, and each subset is local to a procedure, or visible only to that procedure. A subset of stacked registers corresponding to a procedure is referred to as a stack frame, which may include from 0 to 96 registers, beginning at register GR32. Registers in a stack frame include three different types: the input registers, the local registers, and the output registers. The input registers receive input arguments from a caller. The local registers store temporary values for a “current” procedure, which is a procedure being in execution. The output registers pass output arguments to callees of the current procedure. Immediately after a procedure call, the size of the local register area of the callee's stack frame is zero and the input register area overlays the caller's output register area. Stacked registers in a stack frame are mapped to physical registers that operate as a circular buffer.

### The Alloc Statement

In one embodiment, an alloc statement is used to allocate stacked registers for a procedure. In effect, the alloc statement changes the size of a register stack frame. The alloc statement includes an input parameter, a local parameter, and an output parameter that identify a number I of input registers, a number L of local registers, and a number O of output registers to be allocated, respectively. In one embodiment, the parameters are in the order of input, local, and output. The format of the alloc statement may be expressed as:

alloc ( . . . , I, L, O, . . . )

In one embodiment, a procedure is associated with an alloc statement. That is, the stacked registers allocated by that alloc statement are for use in that procedure. Further, an alloc statement called subsequent to a previous alloc statement in a procedure starts the stack frame of that procedure at the same place as the previous alloc statement does. However, an alloc statement of a callee starts the stack frame of the callee at the start of the output area of the caller.

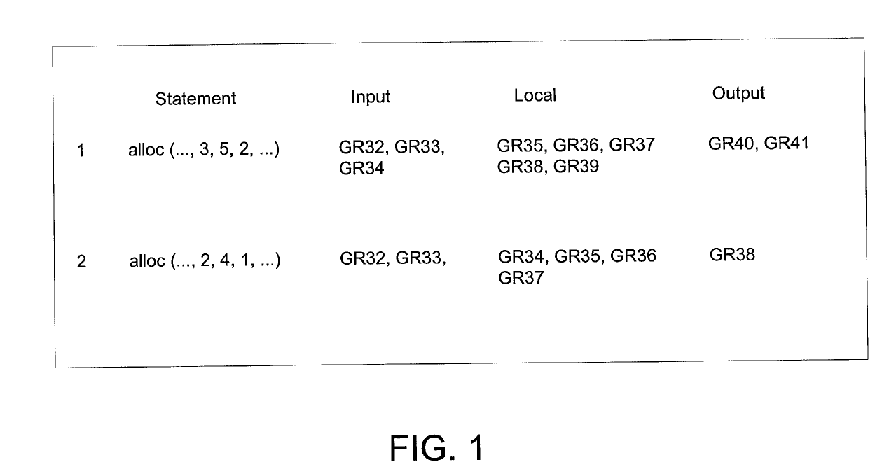

Referring to FIG. 1 for an explanation of how registers are allocated in accordance with the alloc statements in one embodiment. In row one, the first statement alloc ( . . . , 3, 5, 2, . . . ) indicates that I=3, L=5, and O=2 and that ten (3+5+2) registers are to be allocated in which 3 registers are input, 5 registers are local, and 2 registers are output. In this example, the first name for a stacked register is GR32, in accordance with one embodiment. Consequently, the names for three input registers are GR32, GR33, and GR34, for five local registers are GR35, GR36, GR37, GR38, and GR39, and for two output registers are GR40 and GR41. In row two, for illustration purposes, a second statement alloc ( . . . , 2, 4, 1, . . . ) is invoked in the same procedure and subsequent to the statement alloc ( . . . , 3, 5, 2, . . . ) in row one. Consequently, the register stack frame is resized to seven (2+4+1) registers, and the register names are GR32, GR33 for input, GR34, GR35, GR36, and GR37 for local, and GR38 for output.

### The Correspondece Between Alloc Statements, Stack Frames, Stacked Registers, and Physical Registers

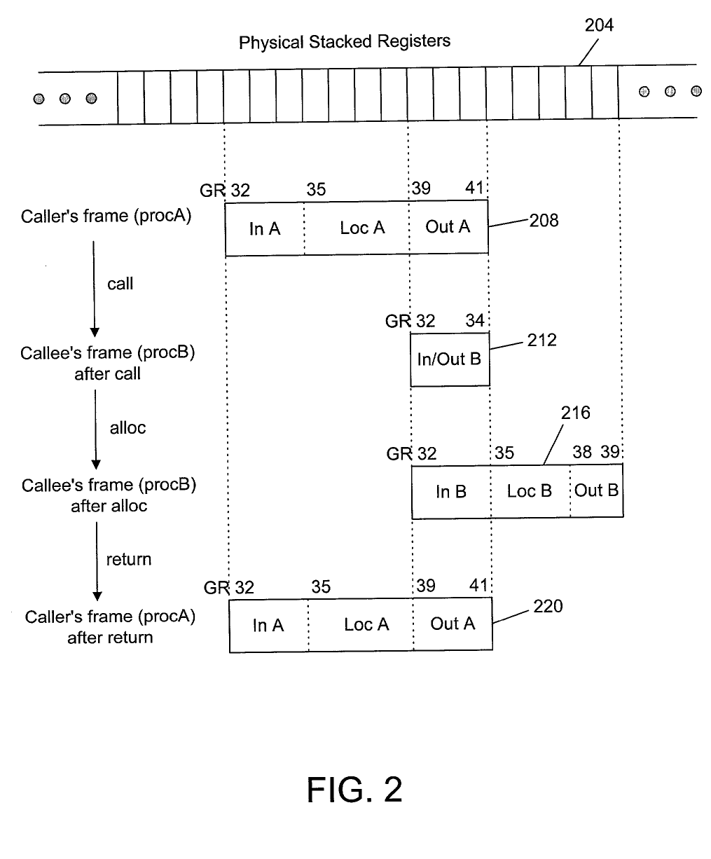

Refer to FIG. 2 for an illustration of the correspondence between the alloc statements, the stack frames, the stacked registers, and the physical registers. In this FIG. 2, a procedure A (procA—the caller) calls a procedure B (procB—the callee), a statement alloc ( . . . , 3, 4, 3, . . . ) is invoked for procA, and an alloc statement ( . . . , 3, 3, 2, . . . ) is invoked for procB. Physical area 204 is for mapping stacked registers to physical registers. Stack frames 208 and 220 correspond to procA before and after procA calls procB, respectively. Both stack frames 208 and 220 include three input registers GR32 to GR34, four local registers GR35 to GR38, and three output registers GR39 to GR41, in accordance with the statement alloc ( . . . , 3, 4, 3, . . . ). Stack frames 212 and 216 correspond to procB immediately after procA calls procB and after procB executes the statement alloc ( . . . , 3, 3, 2, . . . ), respectively. Stack frame 216 includes the input registers only while stack frame 220 includes input, local, and output registers. Furthermore, the input area of the callee procB overlays the output area of the caller procA.

### The Method Step in Accordance with One Embodiment

In one aspect of the techniques disclosed herein, code instrumentation may use registers, and the content in the registers as seen by the original code is to remain unchanged by the code instrumentation. Consequently, during instrumentation, new registers that are distinct from registers used in the original code are to be allocated for use in the probe code.

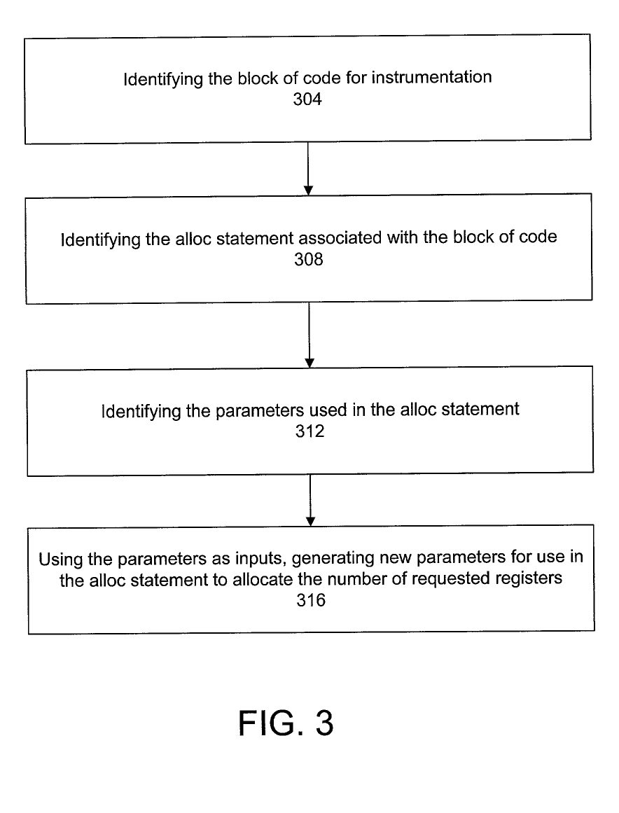

FIG. 3 is a flowchart illustrating the method steps in allocating an N number of registers for use in code instrumentation in accordance with one embodiment.

In step 304, the block of code for code instrumentation is identified.

In step 308, the alloc statement associated with the block of code is identified.

In step 312, the parameters associated with the alloc statement are identified.

In step 316, the parameters associated with the alloc statement are used as inputs to generate new parameters based on which the N number of registers to be used in code instrumentation are to be allocated. In one embodiment, the number N of requested registers is added to the output parameter O of the alloc statement. In effect, N number of new output registers are to be allocated in addition to the total number of registers previously allocated for that same alloc statement.

### EXAMPLE

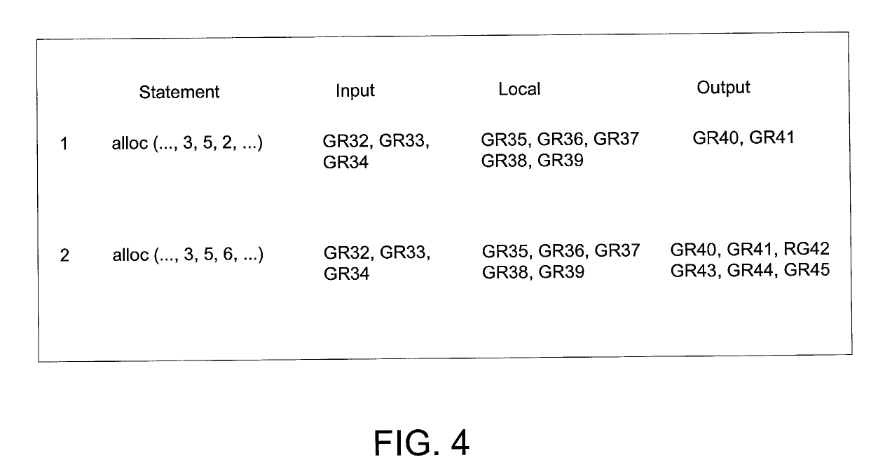

Referring to FIG. 4 for an illustration of how four (N=4) number of new registers are to be allocated in accordance with one embodiment. Row one in FIG. 4 is the same as row one in FIG. 1, i.e., the statement alloc ( . . . , 3, 5, 2, . . . ) indicates that input registers GR32, GR33 and GR34, local registers GR35, GR36, GR37, GR38, and GR39, and output registers GR40 and GR41 have been allocated for a block of code associated with that alloc statement. Row two having the statement alloc ( . . . , 3, 5, 6, . . . ) indicates that three input registers, five local registers, and six output registers are to be allocated for the instrumented code. The three input registers and five local registers have the same names as in the original code as GR32, GR33, and GR34, and GR35, GR36, GR37, GR38, and GR39, respectively. The six output registers include the two output registers GR40 and GR41 used in the original code and four requested registers having names GR42, GR43, GR44, and GR45 for use in the instrumented code.

### Benefits of the Invention

In many aspects, the disclosed techniques are fast and easy to implement. They do not require a data flow analysis to find registers that can be used in the instrumentation code. These registers may be obtained as long as, in one embodiment, the total number of stacked registers allocated in an alloc statement does not exceed 96. In various embodiments, because the newly allocated registers are stacked registers, allocating them in accordance with the techniques disclosed herein does not require explicit save and restore operations that increase both the code size and memory traffic during run time. Further, in the IA-64 architecture, because output registers are not saved and restored in a procedure call, allocating additional output registers does not introduce additional RSE activity, which may save and restore the content of registers between the register stack and memory. Furthermore, because only output registers are allocated, the name of stacked registers used in the original code remains the same, and therefore no register renaming is needed.

### Computer System Overview

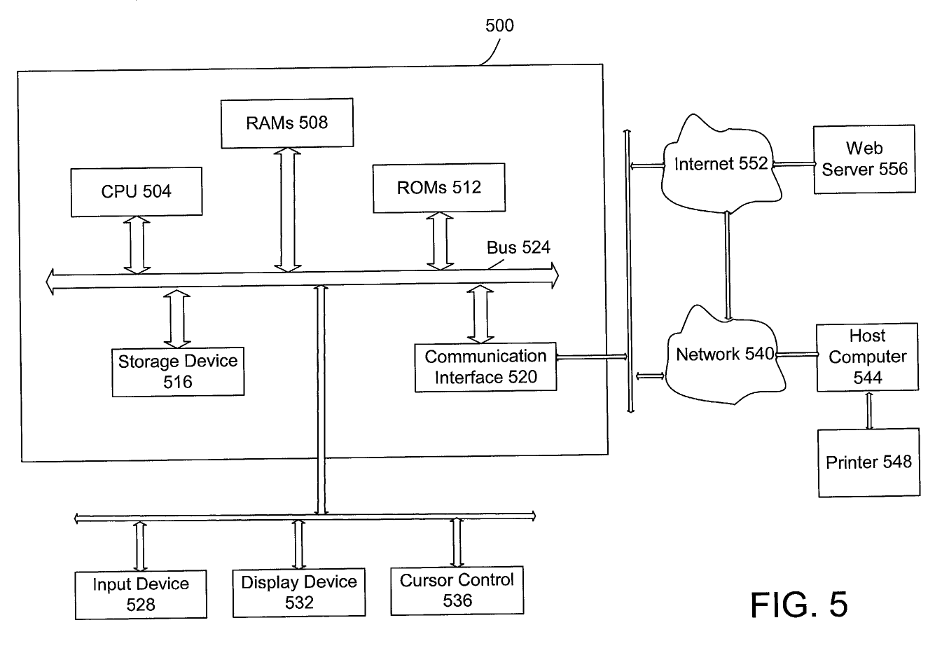

FIG. 5 is a block diagram showing a computer system 500 upon which an embodiment of the invention may be implemented. For example, computer system 500 may be implemented to perform the code instrumentation or implement the techniques disclosed herein, such as the exemplary method discussed above. In one embodiment, computer system 500 includes a processor 504, random access memories (RAMs) 508, read-only memories (ROMs) 512, a storage device 516, and a communication interface 520, all of which are connected to a bus 524.

Processor 504 controls logic, processes information, and coordinates activities within computer system 500. In one embodiment, processor 504 executes instructions stored in RAMs 508 and ROMs 512, by, for example, coordinating the movement of data from input device 528 to display device 532.

RAMs 508, usually being referred to as main memory, temporarily store information and instructions to be executed by processor 504. Information in RAMs 508 may be obtained from input device 528 or generated by processor 504 as part of the algorithmic processes required by the instructions that are executed by processor 504.

ROMs 512 store information and instructions that, once written in a ROM chip, are read-only and are not modified or removed. In one embodiment, ROMs 512 store commands for configurations and initial operations of computer system 500.

Storage device 516, such as floppy disks, disk drives, or tape drives, durably stores information for used by computer system 500.

Communication interface 520 enables computer system 500 to interface with other computers or devices. Communication interface 520 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 520 may also allow wireless communications.

Bus 524 can be any communication mechanism for communicating information for use by computer system 500. In the example of FIG. 5, bus 524 is a media for transferring data between processor 504, RAMs 508, ROMs 512, storage device 516, communication interface 520, etc.

Computer system 500 is typically coupled to an input device 528, a display device 532, and a cursor control 536. Input device 528, such as a keyboard including alphanumeric and other keys, communicates information and commands to processor 504. Display device 532, such as a cathode ray tube (CRT), displays information to users of computer system 500. Cursor control 536, such as a mouse, a trackball, or cursor direction keys, communicates direction information and commands to processor 504 and controls cursor movement on display device 532.

Computer system 500 may communicate with other computers or devices through one or more networks. For example, computer system 500, using communication interface 520, communicates through a network 540 to another computer 544 connected to a printer 548, or through the world wide web 552 to a server 556. The world wide web 552 is commonly referred to as the “Internet.” Alternatively, computer system 500 may access the Internet 552 via network 540.

Computer system 500 may be used to implement the techniques described above. In various embodiments, processor 504 performs the steps of the techniques by executing instructions brought to RAMs 508. In alternative embodiments, hard-wired circuitry may be used in place of or in combination with software instructions to implement the described techniques. Consequently, embodiments of the invention are not limited to any one or a combination of software, hardware, or circuitry.

Instructions executed by processor 504 may be stored in and carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic, or light waves, etc. As an example, the instructions to be executed by processor 504 are in the form of one or more software programs and are initially stored in a CD-ROM being interfaced with computer system 500 via bus 524. Computer system 500 loads these instructions in RAMs 508, executes some instructions, and sends some instructions via communication interface 520, a modem, and a telephone line to a network, e.g. network 540, the Internet 552, etc. A remote computer, receiving data through a network cable, executes the received instructions and sends the data to computer system 500 to be stored in storage device 516.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for allocating an N number of registers for use in conjunction with modification of a block of programming code, comprising the steps of:
identifying a statement allocating registers, the statement being associated with the block of programming code;
identifying parameters associated with the statement; and
by using the parameters as inputs, generating new parameters for use in the statement to allocate the N number of registers.

2. The method of claim 1 wherein the parameters and the new parameters each include a parameter identifying a number I of input registers, a parameter identifying a number L of local registers, and a parameter identifying a number O of output parameters.

3. The method of claim 2 wherein the step of generating new parameters comprises the step of modifying the number O of the parameters to generate the number O of the new parameters.
